(19) United States
(12) Patent Application Publication
(10) Pub. No.: US 2009/0046989 A1
(43) Pub. Date: Feb. 19, 2009

(54) METHOD OF CONTROLLING RECORDING QUALITY

(75) Inventor: Park Jinseok, Gyeonggi-do (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/189,350

(22) Filed: Aug. 11, 2008

(30) Foreign Application Priority Data
Aug. 13, 2007 (KR) 10-2007-0081457

(51) Int. Cl. H04N 5/91

(52) U.S. Cl. 386/83

(57) ABSTRACT

A method of controlling recording quality is disclosed. The method includes determining whether a recording function is set, and determining a recording quality of a broadcast program based on analysis on a data amount of the broadcast program and a recordable capacity of a data storage if the recording function is set, followed by recording the broadcast program on the data storage according to the recording quality.

### BACKGROUND OF THE INVENTION

1. Field of the Invention

The present invention relates to a method of recording a desired TV program in a television with a recording function, and more particularly to a method of controlling recording quality.

2. Description of the Related Art

In recent years, set-top boxes or digital televisions have been widely used to receive programs from a digital TV broadcasting system that supplies high definition video and audio. Among these televisions, a so-called recording function television has a personal video recorder (PVR) function, i.e. a function of automatically recording desired broadcast programs on a hard disk drive (HDD) embedded inside the television to reproduce the broadcast programs at a desired time.

The recording function television can automatically record several dozen hours of broadcast programs on the HDD without a separate setting operation and can reproduce the broadcast programs in response to a request from the user. The recording function television can also record and reproduce a certain broadcast program according to a request from the user.

Differently from tapes for a conventional analogue video cassette recorder (VCR), the recording function television can record broadcast programs, pictures, music, and the like in the form of digital data on the PVR, securing high quality video and audio without loss of information even after repeated recording and reproducing operations while allowing the user to watch the recorded broadcast programs and the like at any desired time.

Further, the recording function television can permit the received broadcast programs to be recorded and then reproduced or to be simultaneously reproduced and recorded by means of the HDD. For example, the recording function television can record real-time broadcast programs on the HDD via a time-shift function, a reservation recording function, an immediate recording function, etc. to allow the user to watch the broadcast programs at any desired time.

However, since such a conventional recording function television employs the HDD, which has a limited capacity, it often experiences a failure of recording additional broadcast programs due to lack of a recordable capacity (space) when a predetermined data amount of broadcast programs have been already recorded thereon.

To solve this problem, it is necessary for the user to select and erase the previously recorded broadcast programs to secure a recordable capacity for recording new broadcast programs.

Alternatively, the recording function television can be configured to analyze the recordable capacity of the HDD therein to issue an alarm message (guide broadcasting or guide caption), which informs the user of lack of the recordable capacity of the HDD, thereby allowing the user to make instructions as to continuation or stoppage of the recording operation. Alternatively, the recording function television can be configured to erase old broadcast programs and record new broadcast programs thereon.

In this case, however, the conventional recording function television can undesirably erase the broadcast programs irrespective of user's intention. Therefore, there is a need for an improved technique that solves these problems.

### SUMMARY OF THE INVENTION

The present invention is conceived to solve the problems of the conventional techniques as described above, and an aspect of the present invention is to provide a method of controlling recording quality according to analysis results on a recordable capacity of a storage medium of a television having a recording function.

In accordance with an aspect of the present invention, a method of controlling recording quality is provided, including: determining whether a recording function is set; and determining a recording quality of a broadcast program based on analysis on a data amount of the broadcast program and a recordable capacity of a data storage if the recording function is set, followed by recording the broadcast program on the data storage according to the recording quality.

The recording quality may be divided into multiple stages according to the recordable capacity of the data storage with respect to the data amount of the broadcast program.

The data amount of the broadcast program may be analyzed using an electronic program guide.

The recording of the broadcast program on the data storage may include determining whether the recordable capacity of the data storage is sufficient, by comparing the data amount of the broadcast program with the recordable capacity of the data storage; and recording the broadcast program on the data storage in a lower recording quality than in a standard recording quality of the broadcast program if the recordable capacity of the data storage is insufficient.

The method may further include changing the recording quality of the broadcast program according to a variation of the recordable capacity by analyzing the recordable capacity of the data storage during the recording of the broadcast program.

The changing of the recording quality of the broadcast program may include determining whether the recordable capacity of the data storage is sufficient, by comparing the data amount of the broadcast program with the recordable capacity of the data storage; and recording the broadcast program on the data storage in a lower recording quality than in a current recording quality of the broadcast program if the recordable capacity of the data storage is insufficient.

The changing of the recording quality of the broadcast program may include analyzing a remaining or exceeding data amount of the broadcast program; and changing the recording quality of the broadcast program by comparing the remaining or exceeding data amount of the broadcast program with the recordable capacity of the data storage.

The recording quality may be divided into multiple stages according to the recordable capacity of the data storage with respect to the remaining or exceeding data amount of the broadcast program.

### BRIEF DESCRIPTION OF THE DRAWINGS

The above and other features and advantages of the present invention will become apparent from the following description of exemplary embodiments given in conjunction with the accompanying drawings, in which:

FIG. 1 is a diagram of the inner configuration of a recording function television according to one embodiment of the present invention;

FIG. 2 is a flow chart of a method of controlling recording quality according to one embodiment of the present invention; and

FIG. 3 is a flow chart of a method of controlling recording quality according to another embodiment of the present invention.

### DETAILED DESCRIPTION OF THE INVENTION

Exemplary embodiments of the present invention will be described in detail with reference to the accompanying drawings hereinafter.

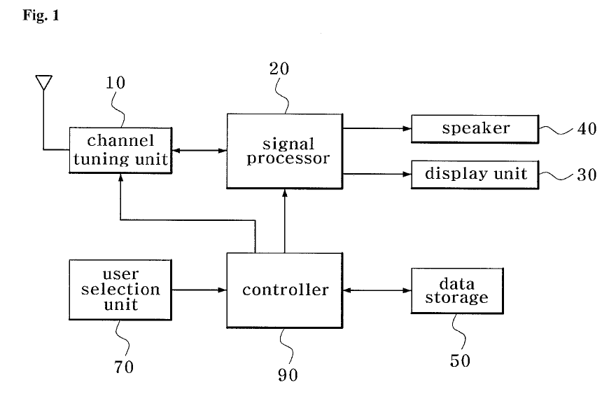

FIG. 1 is a diagram of the inner configuration of a recording function television according to one embodiment of the present invention.

A method of controlling recording quality according to one embodiment of the present invention can be applied to a television that has a personal video recorder (PVR) function, i.e. a function of automatically recording a desired broadcast program on a hard disk drive embedded inside the television to reproduce the broadcast program at a desired time (hereinafter, such a television will simply referred to as a “recording function television”).

The recording function television per se determines a recordable capacity of a storage medium, such as the hard disk drive and the like, and performs a recording operation according to a standard recording quality of a broadcast program if it is determined that the storage medium has a sufficient recordable capacity. Conversely, if it is determined that the storage medium has an insufficient recordable capacity, the recording function television changes the recording quality to be lower than the standard recording quality and performs the recording operation according to the lower recording quality of the broadcast program.

Namely, since the broadcast program to be recorded can have different data capacities according to the recording quality, the recording function television adjusts the data capacity through change of the recording quality and thus can record new broadcast programs on the storage medium without erasing other broadcast programs, which have been previously recorded on the storage medium.

In FIG. 1, the recording function television according to one embodiment of the present invention includes a channel tuning unit 10, a signal processor 20, a display unit 30, a speaker 40, a data storage 50, a user selection unit 70, and a controller 90.

The channel tuning unit 10 may comprise single or plural tuners for tuning broadcasting signals, which have been received through an antenna, and a demodulator for outputting the tuned broadcasting signals in the form of a transport stream via demodulation, error correction, and the like. The channel tuning unit 10 tunes the broadcasting signals in a frequency band which corresponds to a tuning control signal from the controller 90.

The signal processor 20 processes the broadcasting signals, as tuned via the channel tuning unit 10, and allows the processed broadcasting signals to be displayed on the display unit 30. The signal processor 20 processes not only the broadcasting signal received through the channel tuning unit 10, but also a video signal of an electronic program guide (EPG) stored in the data storage 50, so that the video signal of the EPG can also be displayed on the display unit 30. The EPG refers to organization information of broadcast programs individually sent from broadcasting stations or secondary broadcasting stations.

The display unit 30 serves to output video signals, which have been decoded through the signal processor 20, among broadcasting signals of a selected channel, so that the user can watch the processed video signals. The display unit 30 can be applied to a variety of display modules such as digital light processing (DLP) displays, light crystal displays (LCDs), plasma display panels (PDPs), etc.

The speaker 40 serves to output audio signals, which have been decoded through the signal processor 20, among the broadcasting signals of the selected channel, so that the user can listen to the processed audio signals.

The data storage 50 includes a hard disc drive to store the EPG or the broadcasting signals received through the channel tuning unit 10.

The user selection unit 70 includes a variety of menu keys for controlling the controller 90 to allow the user to request reservation or real-time recording on the data storage through the associated menu keys. The user selection unit 70 may be provided to a main panel of the television or may be provided as a wireless remote controller. In the case where the user selection unit 70 is provide as the wireless remote controller, wireless communication apparatuses are further provided to the television and the user selection unit 70 including the menu keys to perform communication between the user selection unit 70 and the controller of the television.

The controller 90 includes a CPU or a microprocessor to output a selected broadcast program through the speaker 40 and the display unit 30 among the broadcasting signals tuned by the channel tuning unit 10, and to store the broadcasting signals in the data storage 50. Particularly, the controller 90 can determine a recordable capacity of a storage medium, i.e. data storage 50 to control a recording quality according to the recordable capacity.

According to this embodiment, although a recording operation can be performed by setting a recording quality of a broadcast program at an initial stage of the recording operation, it is also possible to change the recording quality at any time during the recording operation by continuously monitoring the recordable capacity.

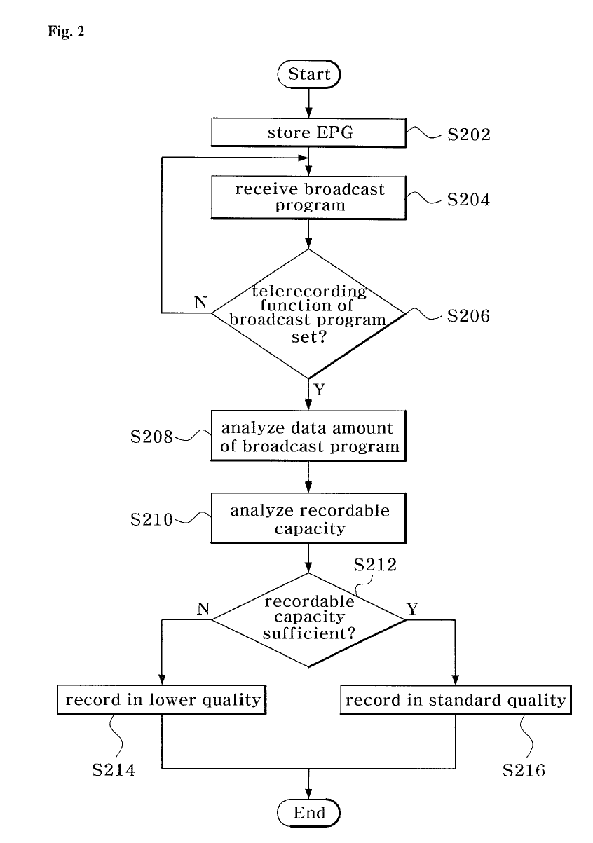

FIG. 2 is a flow chart of a method of controlling recording quality according to one embodiment of the present invention, and particularly shows the method of controlling the recording quality at an initial stage of the recording operation.

First, the recording function television receives EPGs supplied from respective broadcasting stations through the channel tuning unit 10 and stores them in the data storage 50 in S202.

In addition to the EPGs, the television receives a broadcast program through the channel tuning unit 10 and outputs it through the speaker 40 and the display unit 30 in S204.

In S206, it is determined whether a recording function for the broadcast program is set. Fundamentally, the recording function television has a function of automatically recording broadcast programs, sent in real time from broadcasting stations, on the data storage 50, and a function of recording a broadcast program thereon, which has been reserved by the user. However, when the user does not want such recording functions, the user can stop the recording functions. Thus, it is determined whether the recording function for the broadcast program is set.

If the recording function is not set, the recording function television simply receives and displays the broadcast programs in S204.

If the recording function is set, a data amount of a broadcast program is analyzed in S208. When analyzing the data amount of the broadcast program, the EPG stored in the data storage 50 can be employed. In other words, since the EPG includes information as to a start time, an end time, the kind (movie, news, sports, etc.) of each broadcast program, and the like, the data amount of the broadcast program can be analyzed in association with the EPG information with respect to the broadcast program.

In addition to the data amount of the broadcast program, a recordable capacity of the data storage 50 is analyzed in S210. In this case, by analyzing a total recordable capacity and a current recorded capacity of the data storage 50, it is possible to determine a remaining recordable capacity of the data storage 50.

Then, it is determined in S212 whether the data storage has a sufficient recordable capacity for recording the broadcast program by comparing the data amount of the broadcast program with the analyzed recordable capacity of the data storage 50.

If the data storage 50 has an insufficient recordable capacity, the broadcast program is recorded in a lower recording quality on the data storage 50 than in a standard recording quality of the broadcast program in S214. Conversely, if it is determined that the data storage 50 has a sufficient recordable capacity, the broadcast program is recorded in the standard recording quality of the broadcast program on the data storage 50 in S216.

In this embodiment, the broadcast program can be recorded in the lower recording quality or in the standard recording quality. However, the present invention is not limited thereto, and the recording quality of the broadcast program can be divided into multiple stages according to the recordable capacity of the data storage 50 with respect to the data amount of the broadcast program, so that the recording function television can change the recording quality in a variety of degrees.

For example, if the recordable capacity significantly exceeds the data amount of the broadcast program, the recording quality can be set to a high quality, and if the recordable capacity is substantially similar to the data amount of the broadcast program, the recording quality can be set to a normal quality. If the recordable capacity is two thirds of the data amount of the broadcast program, the recording quality can be set to a middle quality, and if the recordable capacity is one thirds of the data amount of the broadcast program, the recording quality can be set to a low quality.

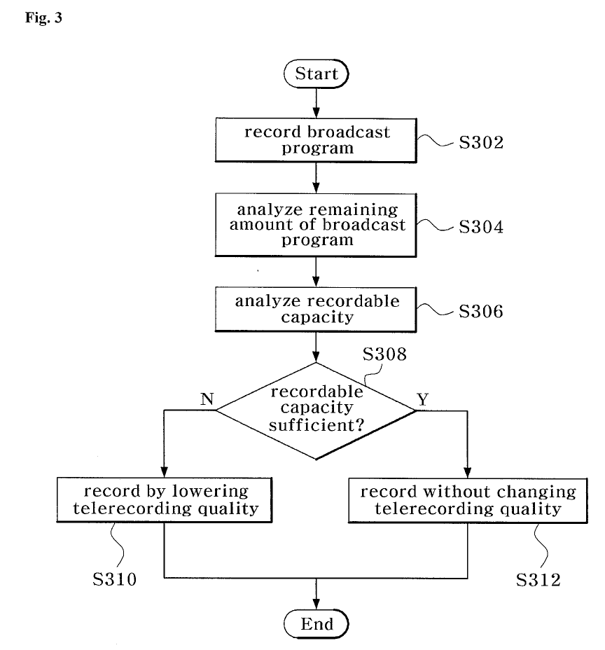

FIG. 3 is a flow chart of a method of controlling recording quality according to another embodiment of the present invention, and particularly shows the method of controlling the recording quality at a middle stage of the recording operation.

In the method of controlling the recording quality shown in FIG. 2, the recording quality is controlled by analyzing the data amount of the broadcast program and the recordable capacity of the data storage 50 in the initial stage of the recording operation. In the method of controlling the recording quality shown in FIG. 3, the recording quality is controlled by continuously analyzing the recordable capacity of the data storage 50 while the recording operation is carried out in a selected recording quality.

Although most broadcast programs are broadcast according to an assigned schedule and time, a sports program or other particular programs are often broadcast over the scheduled broadcasting time.

In this case, a data amount of such a broadcast program can exceed the data amount of the scheduled broadcast program, as analyzed by a process of analyzing a broadcasting amount in S208 illustrated in FIG. 2, thereby exceeding the recordable capacity of the data storage 50. In other words, if the data amount of the broadcast program analyzed in the process of analyzing the broadcasting amount in S208 exceeds the recordable capacity of the data storage, the recording function television can suffer lack of the recordable capacity due to excessive broadcasting. Further, even when the broadcasting of the program is carried out according to the regular schedule and time, the data amount of the broadcast program analyzed by the process of analyzing the broadcasting amount in S208 can exceed the recordable capacity of the data storage due to change in data capacity of the broadcast program sent from a broadcasting station.

Accordingly, the method of controlling the recording quality shown in FIG. 3 allows the recording function television to control the recording quality by continuously analyzing the recordable capacity of the data storage during the recording operation.

First, the recording function television records a broadcast program according to a preset recording quality in S302.

While recording the broadcast program, the recording function television continuously analyzes a remaining or exceeding data amount of the broadcast program if the broadcasting amount analyzed in S208 is exceeded, in S304. For this purpose, the recording function television continuously receives EPG to update broadcasting information in the data storage 50. In other words, if a broadcasting time is extended, EPG indicating a changed broadcasting schedule can be sent to the recording function television, which in turn analyzes the remaining data amount of the broadcast program according to the changed EPG. Further, if the broadcasting amount analyzed in S208 is exceeded, the recording function television continuously analyzes the exceeding data amount of the broadcast program.

Additionally, the recordable capacity of the data storage 50 is also continuously analyzed in S306.

Then, it is determined in S308 whether the data storage has a sufficient recordable storage for the broadcast program by comparing the remaining amount or the exceeding data amount of the broadcast program with the recordable capacity of the data storage.

If the data storage 50 has an insufficient recordable capacity, the recording quality of the broadcast program is set lower than the current recording quality to record the program at a changed lower recording quality on the data storage 50 in S310. Conversely, if the data storage 50 has a sufficient recordable capacity, the program is recorded on the data storage 50 in S3 12 without being subjected to the recording quality change.

In this embodiment, the recording quality is set lower or is not changed. As described above in the embodiment shown in FIG. 2, however, the present invention is not limited thereto and the recording quality of the broadcast program can be divided into multiple stages according to the recordable capacity of the data storage 50 with respect to the remaining or exceeding data amount of the broadcast program, so that the recording function television can change the recording quality in a variety of degrees.

As apparent from the above description, the method of the invention allows a recording quality to be changed in consideration of a recordable capacity of a storage medium in a television, thereby allowing the television to receive and record new broadcast programs without erasing previously stored broadcast programs.

Although the present invention has been described with reference to the embodiments and the accompanying drawings, it will be apparent to those skilled in the art that the embodiments are given by way of illustration, and that various modifications and equivalent embodiments can be made without departing from the spirit and scope of the present invention. Accordingly, the scope of the present invention should be limited only by the accompanying claims.

What is claimed is:

1. A method of controlling recording quality, comprising:
determining whether a recording function is set; and
determining a recording quality of a broadcast program based on analysis on a data amount of the broadcast program and a recordable capacity of a data storage if the recording function is set, followed by recording the broadcast program on the data storage according to the recording quality.

2. The method according to claim 1, wherein the recording quality is divided into multiple stages according to the recordable capacity of the data storage with respect to the data amount of the broadcast program.

3. The method according to claim 1, wherein the data amount of the broadcast program is analyzed using an electronic program guide.

4. The method according to claim 3, wherein the recording of the broadcast program on the data storage comprises:
determining whether the recordable capacity of the data storage is sufficient, by comparing the data amount of the broadcast program with the recordable capacity of the data storage; and
recording the broadcast program on the data storage in a lower recording quality than in a standard recording quality of the broadcast program, if the recordable capacity of the data storage is insufficient.

5. The method according to claim 3, further comprising:
changing the recording quality of the broadcast program according to a variation of the recordable capacity by analyzing the recordable capacity of the data storage during the recording of the broadcast program.

6. The method according to claim 5, wherein the recording quality is divided into multiple stages according to the recordable capacity of the data storage with respect to the data amount of the broadcast program.

7. The method according to claim 5, wherein the changing of the recording quality of the broadcast program comprises:
determining whether the recordable capacity of the data storage is sufficient, by comparing the data amount of the broadcast program with the recordable capacity of the data storage; and
recording the broadcast program on the data storage in a lower recording quality than in a current recording quality of the broadcast program, if the recordable capacity of the data storage is insufficient.

8. The method according to claim 5, wherein the changing of the recording quality of the broadcast program comprises:
analyzing a remaining or exceeding data amount of the broadcast program; and
changing the recording quality of the broadcast program by comparing the remaining or exceeding data amount of the broadcast program with the recordable capacity of the data storage.

9. The method according to claim 8, wherein the recording quality is divided into multiple stages according to the recordable capacity of the data storage with respect to the remaining or exceeding data amount of the broadcast program.
